(19) United States
(12) Patent Application Publication
(10) Pub. No.: US 2006/0048136 A1
(43) Pub. Date: Mar. 2, 2006

(54) Interception-based resource detection system

(76) Inventors: Jeff de Vries, Sunnyvale, CA (US); Ann Hubbell, Los Altos Hills, CA (US); Greg Zavertnik, San Jose, CA (US)

Correspondence Address: PERKINS COIE LLP, P.O. BOX 2168, MENLO PARK, CA, 94026, US

(21) Appl. No.: 10/926,635

(22) Filed: Aug. 25, 2004

(51) Int. Cl. G06F 9/445

(52) U.S. Cl. 717/174

(57) ABSTRACT

A technique for resource detection involves running an application installer associated with an application and intercepting calls made by the application installer. A system constructed according to the technique can infer what resources are required by the application from the intercepted calls. The system may generate streaming files to facilitate streaming the application associated with the installer to a remote location.

### BACKGROUND

Virtual installation is used to facilitate streaming of software. With virtual installation, software can be virtually installed without actually downloading the software. One technique for virtually installing software involves streaming. Typically, software streaming entails anticipating what files and resources are to be consumed by a program during the streaming. A technique for ensuring that the software has the required resources involves taking a snapshot of a drive before installing a program, installing the program, taking a snapshot after installing the program, and comparing the snapshot before and after the installation to determine what changes have been made to the drive. In this way, the resources to be used by the program can be determined.

However, this technique requires taking snapshots of a drive, which can be time-consuming and may consume relatively large amounts of memory or storage resources.

### BRIEF DESCRIPTION OF THE DRAWINGS

FIG. 1 depicts a networked system for use in an embodiment;

FIG. 2 depicts a computer system for use in the system of FIG. 1;

FIG. 3 depicts a portion of the computer system of FIG. 2 and components of the system of FIG. 1;

FIGS. 4A to 4C illustrate the capture of calls according to an embodiment;

FIGS. 5A and 5B depict data that is recorded in an embodiment;

FIG. 6 depicts a flowchart of an exemplary method for interception-based resource detection;

FIGS. 7A-7K depict screenshots intended to illustrate an exemplary GUI according to an embodiment;

FIG. 8 depicts a flowchart of an exemplary method for jumpstart;

FIG. 9 depicts a flowchart of an exemplary method according to an embodiment.

### DETAILED DESCRIPTION OF THE INVENTION

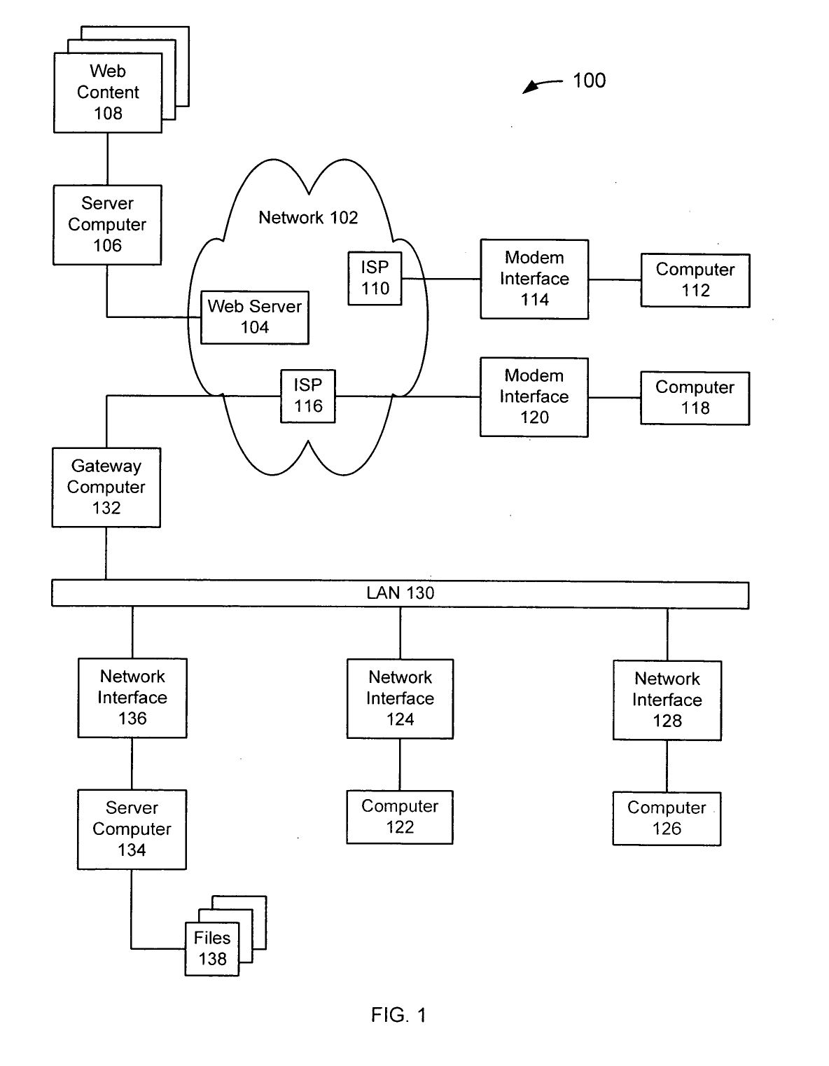

The following description of FIGS. 1-6 is intended to provide an overview of computer hardware and other operating components suitable for performing the methods of the invention described herein, but is not intended to limit the applicable environments. Similarly, the computer hardware and other operating components may be suitable as part of the apparatuses of the invention described herein. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 1 depicts a networked system 100 that includes several computer systems coupled together through a network 102, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). The physical connections of the Internet and the protocols and communication procedures of the Internet are well known to those of skill in the art.

The web server 104 is typically at least one computer system which operates as a server computer system and is configured to operate with the protocols of the world wide web and is coupled to the Internet. The web server system 104 can be a conventional server computer system. Optionally, the web server 104 can be part of an ISP which provides access to the Internet for client systems. The web server 104 is shown coupled to the server computer system 106 which itself is coupled to web content 108, which can be considered a form of a media database. While two computer systems 104 and 106 are shown in FIG. 1, the web server system 104 and the server computer system 106 can be one computer system having different software components providing the web server functionality and the server functionality provided by the server computer system 106, which will be described further below.

Access to the network 102 is typically provided by Internet service providers (ISPs), such as the ISPs 110 and 116. Users on client systems, such as client computer systems 112, 118, 122, and 126 obtain access to the Internet through the ISPs 110 and 116. Access to the Internet allows users of the client computer systems to exchange information, receive and send e-mails, and view documents, such as documents which have been prepared in the HTML format. These documents are often provided by web servers, such as web server 104, which are referred to as being “on” the Internet. Often these web servers are provided by the ISPs, such as ISP 110, although a computer system can be set up and connected to the Internet without that system also being an ISP.

Client computer systems 112, 118, 122, and 126 can each, with the appropriate web browsing software, view HTML pages provided by the web server 104. The ISP 110 provides Internet connectivity to the client computer system 112 through the modem interface 114, which can be considered part of the client computer system 112. The client computer system can be a personal computer system, a network computer, a web TV system, or other computer system. While FIG. 1 shows the modem interface 114 generically as a “modem,” the interface can be an analog modem, isdn modem, cable modem, satellite transmission interface (e.g. “direct PC”), or other interface for coupling a computer system to other computer systems.

Similar to the ISP 114, the ISP 116 provides Internet connectivity for client systems 118, 122, and 126, although as shown in FIG. 1, the connections are not the same for these three computer systems. Client computer system 118 is coupled through a modem interface 120 while client computer systems 122 and 126 are part of a LAN 130.

Client computer systems 122 and 126 are coupled to the LAN 130 through network interfaces 124 and 128, which can be ethernet network or other network interfaces. The LAN 130 is also coupled to a gateway computer system 132 which can provide firewall and other Internet-related services for the local area network. This gateway computer system 132 is coupled to the ISP 116 to provide Internet connectivity to the client computer systems 122 and 126. The gateway computer system 132 can be a conventional server computer system.

Alternatively, a server computer system 134 can be directly coupled to the LAN 130 through a network interface 136 to provide files 138 and other services to the clients 122 and 126, without the need to connect to the Internet through the gateway system 132.

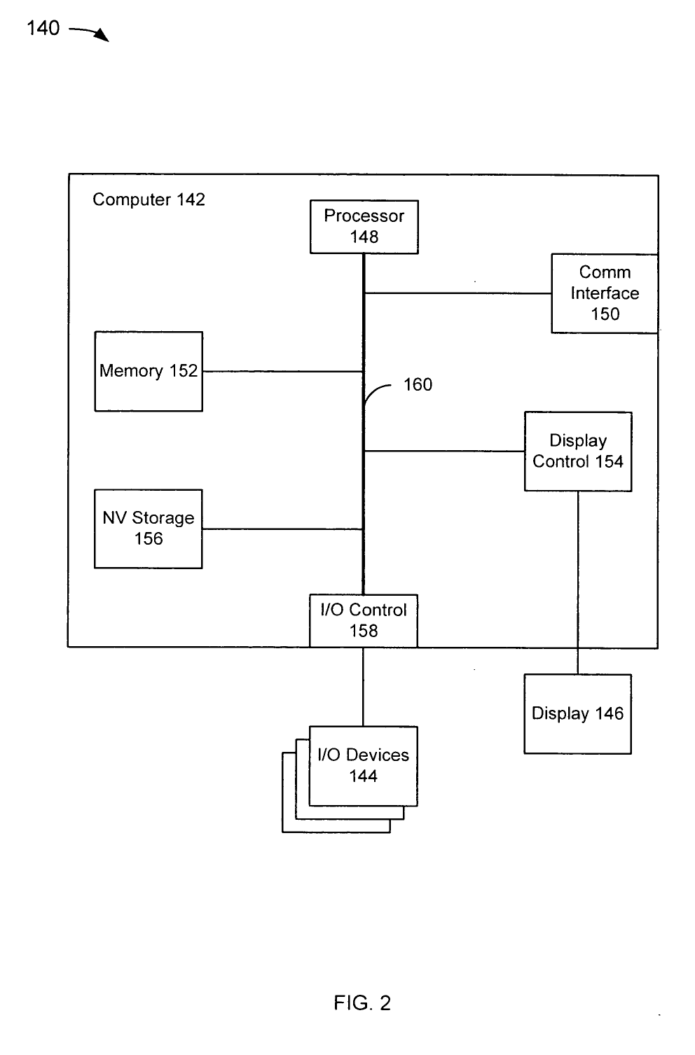

FIG. 2 depicts a computer system 140 for use in the system 100 (FIG. 1). The computer system 140 may be a conventional computer system that can be used as a client computer system or a server computer system or as a web server system. Such a computer system can be used to perform many of the functions of an Internet service provider, such as ISP 110 (FIG. 1). The computer system 140 includes a computer 142, I/O devices 144, and a display device 146. The computer 142 includes a processor 148, a communications interface 150, memory 152, display controller 154, non-volatile storage 156, and I/O controller 158. The computer system 140 may be couple to or include the I/O devices 144 and display device 146.

The computer 142 interfaces to external systems through the communications interface 150, which may include a modem or network interface. It will be appreciated that the communications interface 150 can be considered to be part of the computer system 140 or a part of the computer 142. The communications interface can be an analog modem, isdn modem, cable modem, token ring interface, satellite transmission interface (e.g. “direct PC”), or other interfaces for coupling a computer system to other computer systems.

The processor 148 may be, for example, a conventional microprocessor such as an Intel Pentium microprocessor or Motorola power PC microprocessor. The memory 152 is coupled to the processor 148 by a bus 160. The memory 152 can be dynamic random access memory (dram) and can also include static ram (sram). The bus 160 couples the processor 148 to the memory 152, also to the non-volatile storage 156, to the display controller 154, and to the I/O controller 158.

The I/O devices 144 can include a keyboard, disk drives, printers, a scanner, and other input and output devices, including a mouse or other pointing device. The display controller 154 may control in the conventional manner a display on the display device 146, which can be, for example, a cathode ray tube (CRT) or liquid crystal display (LCD). The display controller 154 and the I/O controller 158 can be implemented with conventional well known technology.

The non-volatile storage 156 is often a magnetic hard disk, an optical disk, or another form of storage for large amounts of data. Some of this data is often written, by a direct memory access process, into memory 152 during execution of software in the computer 142. One of skill in the art will immediately recognize that the terms “machine-readable medium” or “computer-readable medium” includes any type of storage device that is accessible by the processor 148 and also encompasses a carrier wave that encodes a data signal.

The computer system 140 is one example of many possible computer systems which have different architectures. For example, personal computers based on an Intel microprocessor often have multiple buses, one of which can be an I/O bus for the peripherals and one that directly connects the processor 148 and the memory 152 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 152 for execution by the processor 148. A Web TV system, which is known in the art, is also considered to be a computer system according to the present invention, but it may lack some of the features shown in FIG. 2, such as certain input or output devices. A typical computer system will usually include at least a processor, memory, and a bus coupling the memory to the processor.

In addition, the computer system 140 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 156 and causes the processor 148 to execute the various acts required by the operating system to input and output data and to store data in memory, including storing files on the non-volatile storage 156.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

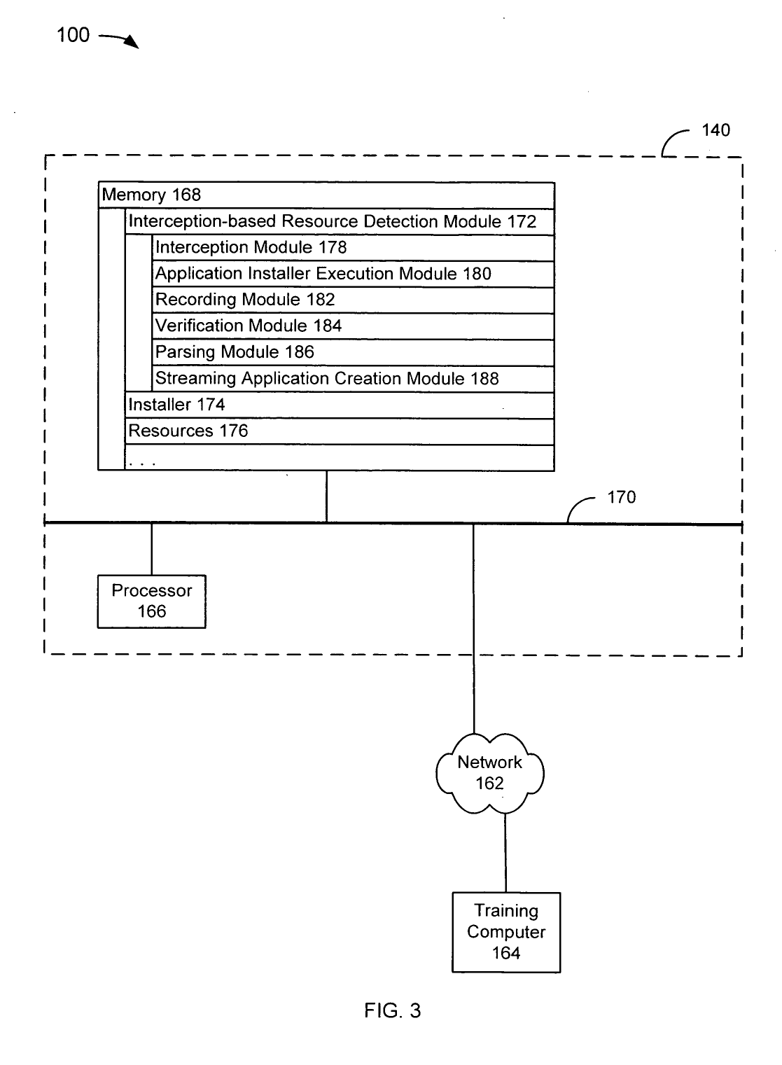

FIG. 3 depicts a portion of the computer system 140 (FIG. 2) and components of the system 100 (FIG. 1). FIG. 3 depicts the computer system 140, a network 162, and a testing computer 164. The network 162 could be a global information network, such as the Internet, a local or wide area network (LAN or WAN), or some other intranet or network. For example, the network 102 (FIG. 1) could include the network 162. Alternatively, the LAN 130 (FIG. 1) could include the network 162. In another alternative, the computer system 140 may by physically or wirelessly coupled to the testing computer 164.

It had been discovered through trial-and-error that a pristine operating environment is important for testing of certain applications, such as streaming applications. To this end, in an embodiment, ghosting is used to ensure a pristine testing environment. Ghosting is a technique that includes preparing a clean environment, creating a copy of a partition associated with the clean environment (the ghosted partition), and overwriting a partition with the ghosted partition to restore the clean environment. Thus, ghosting could be thought of as a “partition, save, restore” procedure. One utility that facilitates ghosting is Norton Ghost™ 7.5. In an embodiment, simply removing applications or performing a conventional backup is insufficient to remove certain files or registry values. For example, performing a conventional backup may remove an application, but leave a registry value related to the application. The registry value may be used again if the application is re-installed. However, in the context of a streaming application, a testing environment must be started anew each time as if the streaming application had never been on the testing machine. Accordingly, in an embodiment, the testing computer 164 may have a ghosted configuration. Alternatively, the testing computer 164 may have a clean operating environment that is accomplished by deleting files and registry value artifacts associated with an application that remain after the application is removed.

The testing computer 164 may be coupled to and accessible through the network 162. The testing computer 164 could be part of a computer system, such as the computer system 140 (FIG. 2). The testing computer 164 may include a processor, a memory, and a bus that couples the processor to the memory. For the purposes of testing, a configuration should include as few irrelevant or distracting applications as possible. Moreover, a testing computer 164 is often desirable in addition to the computer system 140 because artifacts may remain on the computer system 140 after processing an application. For example, if the computer system 140 is used to prepare an application for streaming, the preparation may spawn a registry value that is not incorporated into the streaming application. Since the registry value exists on the computer system 140, the streaming application, if tested on the same computer, may make use of it even though the registry value was not properly captured and incorporated into the streaming application. Then, when the streaming application is run on a different computer, the streaming application may not have the appropriate registry values available to it. For this reason, in an embodiment, a testing computer 164 is used in conjunction with the computer system 140 for processing and testing applications. Alternatively, the computer system 140 could be used to process and test applications. In this alternative, the computer system 140 should be appropriately cleaned or partitioned. It should be noted that though testing is recommended, it is not expressly required. Accordingly, in an embodiment, the testing computer 164 is optional.

The computer system 140 includes a processor 166, a memory 168, and a bus 170 that couples the processor 166 to the memory 168. The memory 168 may include both volatile memory, such as DRAM or SRAM, and non-volatile memory, such as magnetic or optical storage. The processor 166 executes code in the memory 168. The memory 168 includes an interception-based resource detection program 172, an installer 174, and resources 176. Some or all of the applications or data of computer system 140 could be served as Web content, such as by the server computer 106 (FIG. 1). The applications or data could be part of a server computer on a LAN or WAN, such as the server computer 134 (FIG. 1). Programs that are used with an application associated with the installer 174 may be located on the testing computer 164 and may or may not be required on the computer system 140. For example, if the application requires a specific version of DirectX™, Acrobat™, or QuickTime™, the specific version may be required on the testing computer 164. Alternatively, the installer 174 may check to see whether a program, such as DirectX™, is already installed and installs the program if the program is not installed already. The computer system 140 may or may not be ghosted.

The interception-based resource detection program 172 monitors the installer 174 while the installer 174 is executed. The interception-based resource detection program 172 creates a record of resources 176 associated with the installer 174. The resources 176 may include installed files, registry keys, and other resources called or used by the installer 174. In an embodiment, the installer 174 is self-contained such that the installer 174 need not access remote resources. Some or all of the resources 176 may or may not be included in the installer 174. Alternatively, resources may be available from a remote location and downloaded or otherwise provided when the installer 174 is executed. The interception-based resource detection program 172 may infer from the record which resources are needed to stream an application that is associated with the installer 174.

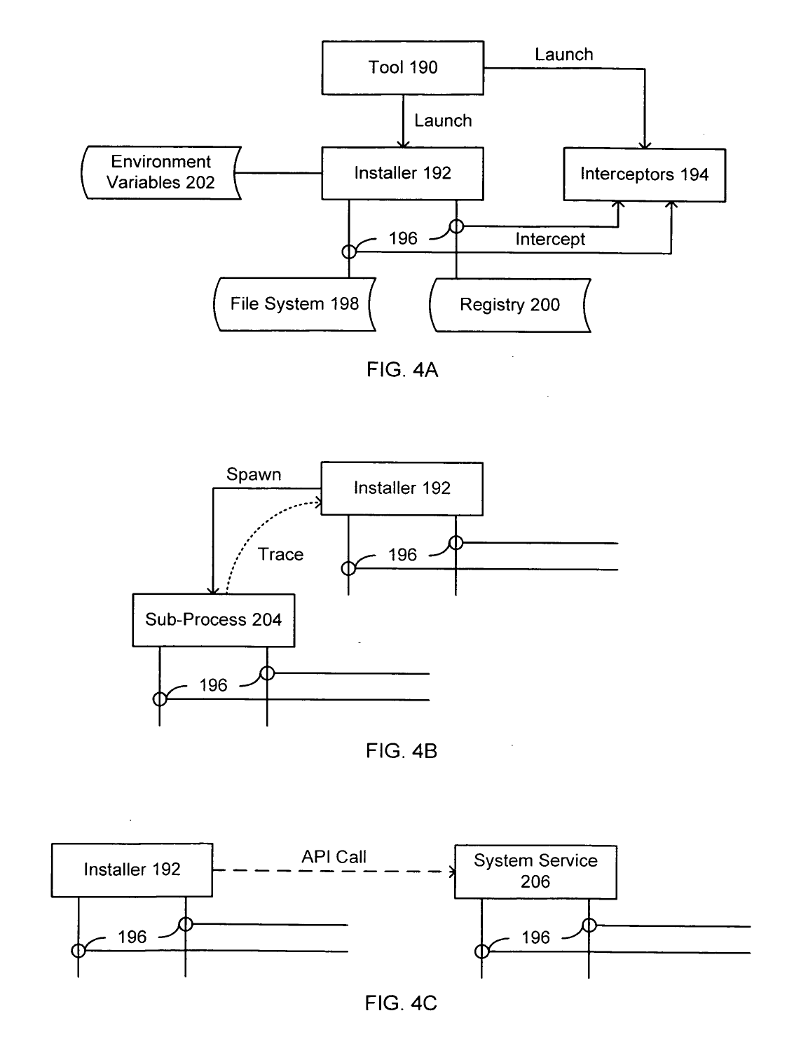

The installer 174 may or may not include sub-processes. For example, the installer 174 may check whether a program, such as DirectX™, is installed and install the program if it is not. The installation of the program may be executed as a sub-process of the installer 174. Another example of a sub-process may include an installer 174 that gathers information from a user in a GUI then launches an installer (sub-process) that makes use of the information. Another example is the Microsoft™ installer, which runs under a service model; the subsystem copies files and creates registry entries. These are only examples. There are a number of different reasons and programming styles that may cause the installer 174 to be divided into multiple sub-processes. The sub-processes may or may not be installers themselves. For example, a sub-process could be invoked by the installer 174 or the sub-process could be invoked directly. A technique is provided herein that enables tracking of activities of the installer 174 and sub-processes of the installer 174. An example of a multi-process installer is described later with reference to FIG. 4B.

The interception-based resource detection program 172 can be logically divided into functional modules. For example, the interception-based resource detection program 172 may include an interception module 178, an application installer execution module 180, a recording module 182, a verification module 184, a parsing module 186, and a streaming application creation module 188.

In an embodiment, the interception module 178 is started prior to executing the installer 174. In an alternative, the interception module 178 could be started at the same time as, or after, the installer 174. The interception module 178 operates in runtime.

The application installer execution module 180 may provide a portion of an environment in which to execute the installer 174. In an embodiment, the interception-based resource detection program 172 provides at least part of the environment. In another embodiment, some or all of the application installer execution module 180 is provided by an operating system or a program for executing application installers, such as the installer 174. In an embodiment, the application installer execution module 180 includes a GUI in which a user may indicate that the installer 174, for example, is to be executed. The application installer execution module 180 then launches the installer 174.

While the installer 174 is running, interceptors associated with the interception module 178 capture calls made by the installer. The calls may include file system, registry, and other calls. It should be noted that the interception of calls may be accomplished by, for example, changing offset values or using a file system hook technique. These techniques are well-known in the art so a detailed description of interception techniques is omitted. FIGS. 4A to 4C illustrate the capture of calls.

As depicted in FIG. 4A, a tool 190 launches an installer 192. The tool may be, for example, the interception-based resource detection program 172. The module of the tool 190 that launches the installer 192 may be, for example, the application installer execution module 180 of the interception-based resource detection program 172. The interceptors 194 monitor certain activities of the installer 192. As previously indicated, the interceptors 194 may be launched prior to the launch of the installer 192. The interceptors 194 may be launched by, for example, the interception module 178 of the interception-based resource detection program 172. In the example of FIG. 4A, the interceptors 194 capture (196) file system calls 198 and registry calls 200. The term “calls” includes any activity that changes the environment in which the installer 192 is executed. In the example of FIG. 4A, the interceptors 194 do not dynamically monitor environment variable calls 202 because the environment variables may be checked after the installer 192 is finished (not shown). However, in an alternative, the interceptors 194 could be configured to dynamically capture every call, interaction, command, or other activity associated with the installer 192. The recording of captured data is described later with reference to the recording module 182 of FIG. 3.

FIG. 4B depicts the installer 192 (FIG. 4A) and a sub-process 204 spawned by the installer 192. As described previously, an installer may spawn a sub-process, which may or may not itself be an installer. The sub-processes themselves may spawn one or more sub-processes. In an embodiment, the interceptors 194 (FIG. 4A) are capable of capturing (196) calls from the sub-process 204 as well as from the installer 192. The tool is capable of determining that the sub-process calls should be captured by the interceptors 194 by, for example, tracing back to the parent process using, for example, parent process IDs. Thus, calls from sub-processes with a hierarchical relationship (e.g., parent-child) with the installer 192 are, in an embodiment, assumed to be relevant and are captured. Conversely, calls made by a process that does not have a hierarchical relationship with the installer 192 can be ignored. In some cases, such as when the installer makes an API call to, for example, a system service, it may be desirable to track calls that cannot be traced back to the parent installer 192.

FIG. 4C depicts the installer 192 (FIG. 4A) and a system service 206 that is invoked by the installer 192 with an API call. The system service 206 may or may not have a hierarchical relationship with the installer 192. Nevertheless, it may be desirable to capture (196) the calls associated with the system service 206. In an embodiment, to ensure that the calls associated with the system service 206 are captured, a table of names is maintained by, or for use by, the tool. The table of names includes a listing of possible system services (e.g., MSI.exe). When a system service that is listed in the table is executed in the context of an installation (e.g., while the installer 192 is running), that system service is assumed to be relevant to the installation. Accordingly, activity by the system service is captured. In an alternative, the interceptors 194 (FIG. 4A) could capture the API call itself and determine that the system service is associated with the installer 192 in the context of the installation.

Referring once again to FIG. 3, the recording module 182 may record installation-related data and infer which resources are to be associated with the installer 174 based upon, for example, the intercepted calls. The recorded data may include directories, files, registry keys, registry values and other data. The recording module 182 may record data as it is captured by the interception module 178 or after the installer 174 has finished. In an alternative, some recording functionality of the recording module 182 is included in the interception module 178. For example, the interception module 178 may both intercept and record calls. In this context, the interception and recording of data may be referred to as capturing data.

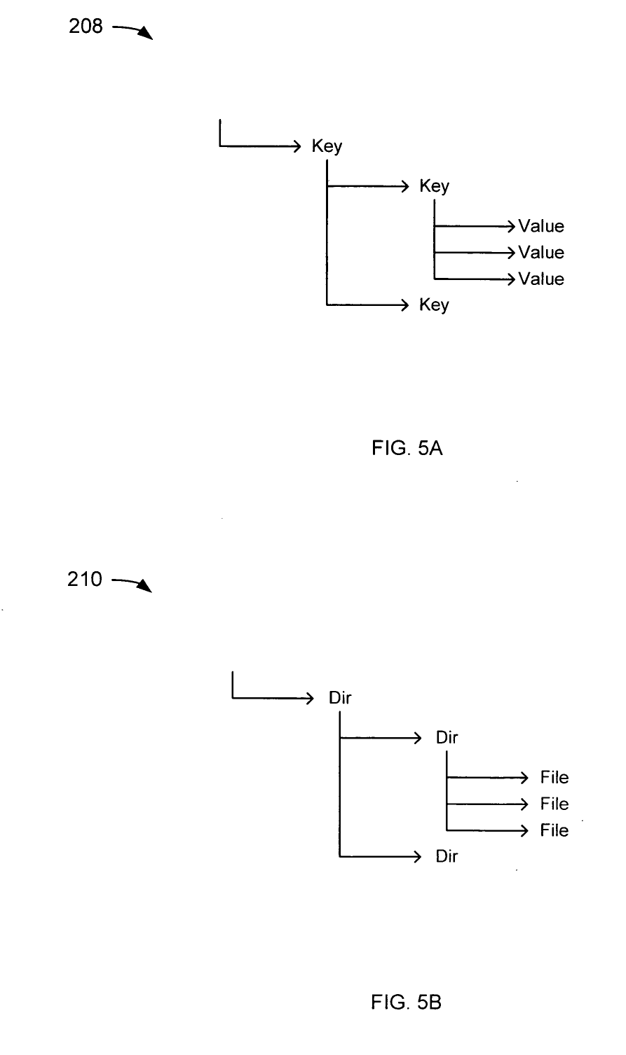

FIGS. 5A and 5B depict data that is recorded by the recording module 182 in an embodiment. As depicted in FIG. 5A, data may include a structure 208 that includes keys and values. The structure 208 is intended to represent registry keys and registry values. The structure 208 may be stored in a tracefile that includes a path to registry values that are created, modified, or deleted while the installer is executed. As depicted in FIG. 5B, data may include a structure 210 that includes directories and files. The structure 210 is intended to represent a file directory that may be stored in a tracefile that includes a path to files that are created, modified, or deleted while the installer is executed. In an embodiment, the tracefile associated with the file directory does not include the actual files (e.g., the tracefile includes only the path). Alternatively, the tracefile could include the actual files.

Referring once again to FIG. 3, in an embodiment, the recording module 182 maintains one or more working files or databases while recording data. These files may be tracefiles that include paths to registry values, paths to files, or both. For example, the files may include a .irb for recording registry path data, a .ifb file for recording file path data, and a .log file for recording exceptions, errors, or other notes. The tracefiles are updated as the interception module 178 captures additional data or after the installer 174 finishes. The tracefiles are optional. The recording module 182 could maintain data in real time instead of generating tracefiles with paths to the data (e.g., files).

The verification module 184 takes over when the installer 174 finishes. It should be noted that the installer 174 may finish before sub-processes or system services finish. In this case, the verification module 184 should not begin until all sub-processes and system services finish. To this end, the verification module 184 may prompt a user to indicate when the installation is complete. Alternatively, the verification module 184 may check to determine that all processes spawned by the installer are finished. In any case, when the installer 174 (and other processes, if applicable) finishes, the interception module 178 turns of the interceptors. The verification module 184 then checks, for example, a logfile to determine whether any errors or notes were recorded by the recording module 182. If the logfile contains entries, the user may be prompted to indicate how to proceed, which may include aborting, restarting, or reconfiguring the installation. If the logfile is empty, the verification module 184 may, for example, delete the logfile.

The parsing module 186 parses the tracefiles to produce streaming application files. The parsing module 186 is optional because the recording module 182 could instead dynamically update registry values and files. However, in an embodiment, the recording module 182 maintains trace files. The parsing module 186 steps through the tracefiles and obtains a value for each path. The parsing module 186 assumes that if a file or registry value cannot be found, it has been deleted. For example, if the installer 174 creates a file, modifies the file, then deletes the file, the tracefile may still include a path to the file. Later, when the parsing module 186 reaches the path associated with the delete, the assumption can be verified. Once the parsing module 186 has stepped through the tracefiles, redundancies and inconsistencies should be reduced or eliminated and the record includes registry values and files. The files may be organized in a list.

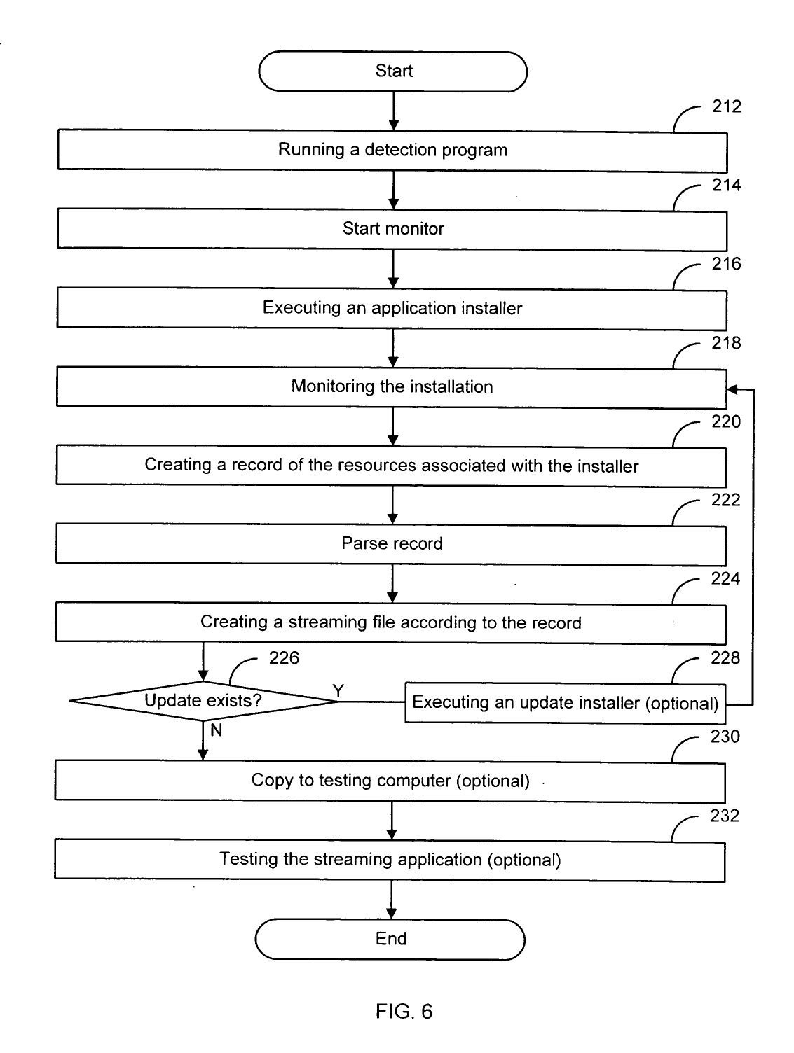

A streaming application creation module 188 may use the record to create a streaming application that facilitates streaming of one or more applications that are associated with the installer 174. In an embodiment, the streaming application includes a token file (e.g., a .tok file) and a stream file (e.g., a .stc file). The streaming application may also include a text file (e.g., a .txt file). The streaming application creation module 188 may create and encode the token file. The token file includes paths to various resources. The token file may be thought of as containing the information necessary to trick a computer that is receiving a streaming application into believing it has all of the resources it needs to run the application. The streaming application creation module 188 may create and process (e.g., compress or encrypt files) the stream file. The stream file includes a series of blocks. The blocks are processed from a list of files that are segmented into blocks. When streaming an application to a computer, the computer may need some of the blocks at any given time. If the computer needs an additional block, the computer may request the additional block from a server and the server will provide the additional block from the stream file. A .stw file may also be created that includes a copy of the record. The .stw file can be merged with subsequent installations of updates or other applications, as described with reference to FIG. 6.

FIG. 6 depicts a flowchart of an exemplary method for interception-based resource detection. The flowchart starts at block 212 with running a detection program. The detection program may be an interception-based detection program, such as the interception-based detection program 172 (FIG. 3). The detection program may be run in the foreground or the background. Alternatively, the detection program could be run after first determining that an installer is going to be executed. The detection program may be locally available, or remotely available for download or streaming.

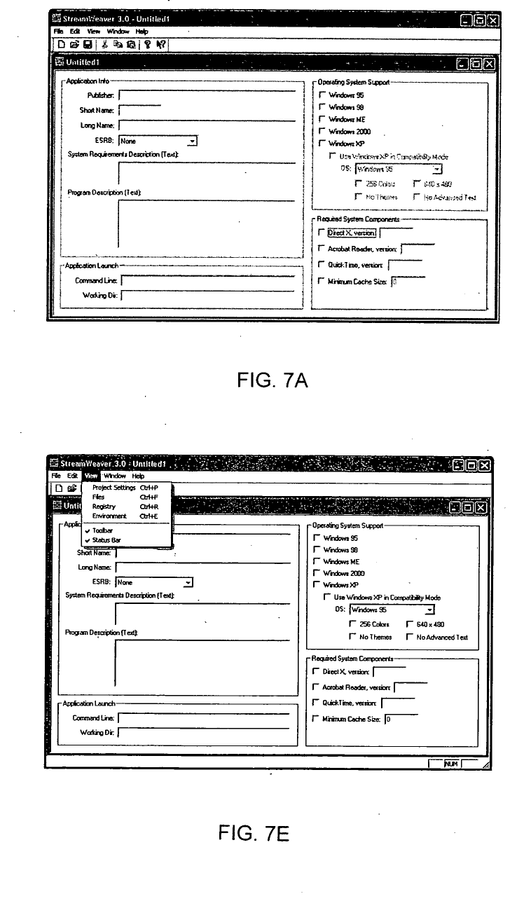

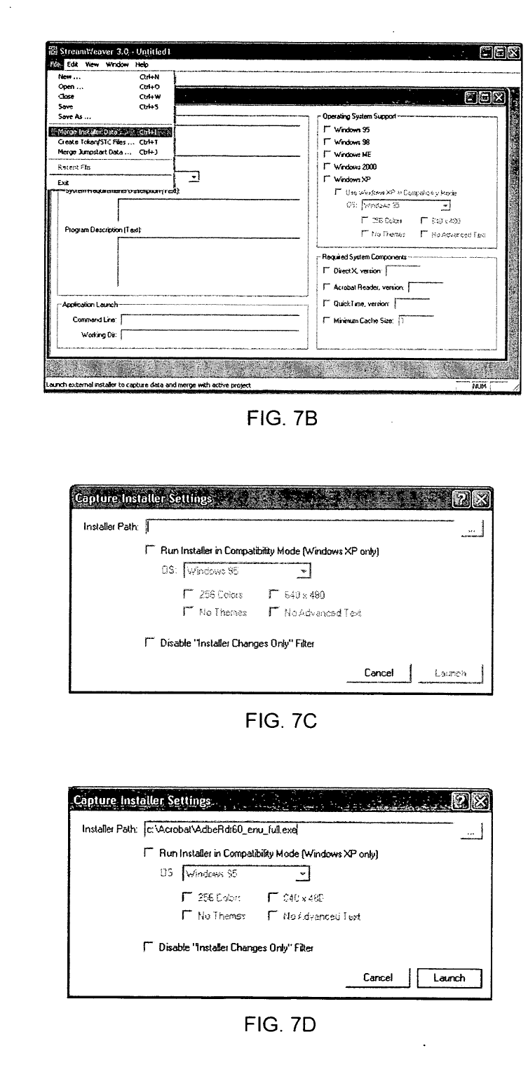

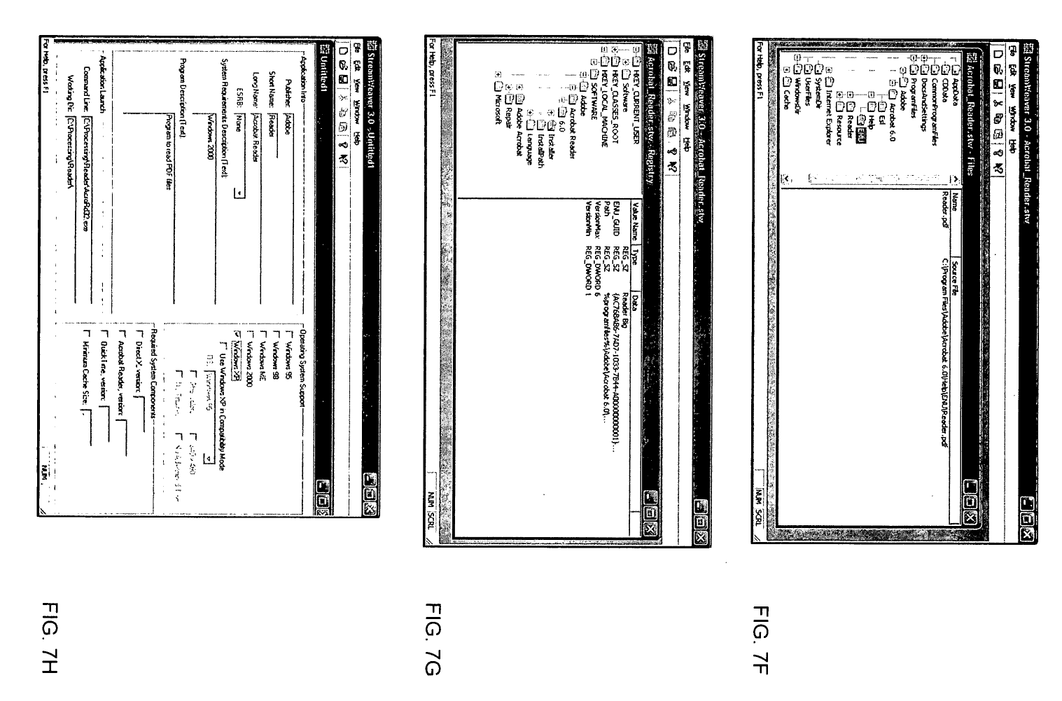

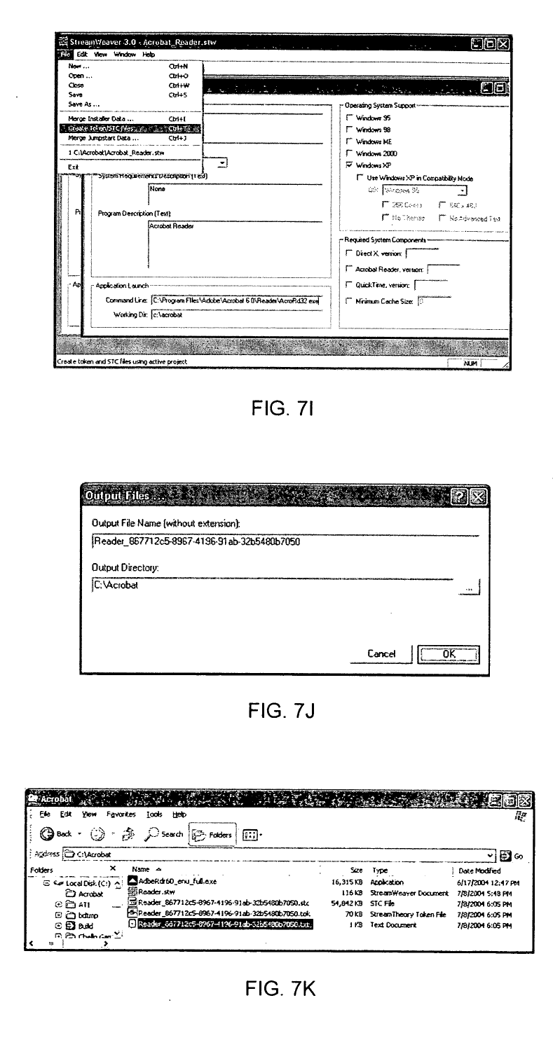

FIG. 7A depicts an exemplary GUI for use with the detection program described with reference to FIG. 6. In the example of FIG. 7A, an untitled application window is displayed, but no data has been entered (e.g., because an application installer has not yet been selected). In the example of FIG. 7A, the detection program is associated with StreamWeaver™ 3.0.

Referring once again to FIG. 6, the flowchart continues at block 214 with starting a monitor. The monitor may be, for example, an interception module, as described with reference to FIG. 3.

The flowchart continues at block 216 with executing an application installer. The application installer is associated with one or more applications. The application installer may be executed from within a window or shell associated with the detection program. For example, a user may be prompted to select an application installer to execute from within a GUI associated with the detection program.

FIG. 7B depicts the GUI of FIG. 7A with the file drop-down menu open and the “Merge Installer Data” menu option highlighted. In the example of FIG. 7B, when the “Merge Installer Data” menu option is selected, a Capture Installer Settings dialogue box, as depicted in FIG. 7C, is displayed. A user may enter a path to an application installer, as depicted in FIG. 7D. When the Launch button is clicked, the application installer is executed.

Referring once again to FIG. 6, the flowchart continues at block 218 with monitoring the installation. The detection program intercepts calls made by the application installer that are associated with, for example, application files, directory locations, directory creation, resources, registry settings, or environment variables. The detection program may monitor both what and where files are loaded and registry values that are set while the application installer is executed. In this way, the detection program may facilitate discovery of unique resources or settings.

The flowchart continues at block 220 with creating a record of the resources associated with the application installer. The resources associated with the application installer may be determined from the calls or other activities associated with the application installer. The record may include files installed and registry keys created.

The flowchart continues at block 222 with parsing the record. Parsing the record may be accomplished by a parsing module, such as the parsing module 186 (FIG. 3). FIGS. 7E to 7H are intended to illustrate an example of how a user might be able to view the record.

As depicted in FIG. 7E, various data associated with an application may be viewed by selecting, for example, one of the menu options from a view drop-down menu. Three exemplary menu options are the files option, registry option, and project setting option.

If, for example, the files option is selected, then a view such as depicted in FIG. 7F may be displayed. In FIG. 7F, the record is entitled “Acrobat_Reader.stw”. This record is associated with Acrobat Reader™, which is used for illustrative purposes only. The record includes reference to a file “Reader.pdf”. Though in this example, the exemplary installer is associated with one installed file, other installers could install multiple files. It should be noted that the files or values associated with the files in the view of FIG. 7F can be changed and new files can be added. The data represented in the view represents what was initially installed by the installer. Change to the files may or may not be reflected in a system directory. Some or all of the values may be incorporated into a token file as described later.

If, for example, the registry option (FIG. 7E) is selected, then a view such as depicted in FIG. 7G may be displayed. In FIG. 7G, the registry includes multiple values associated with the application. It should be noted that the value names and associated values may be changed and new values can be added. The data represented in the view of FIG. 7G represents what was initially installed by the installer. Change to the values may or may not be reflected in a system directory. Some or all of the values may be incorporated into a token file as described later.

If, for example, the project setting option (FIG. 7E) is selected, then a view such as depicted in FIG. 7H may be displayed. In FIG. 7H, various application and system information is displayed. A user may be required to enter some or all of the data, or some or all of the data may be entered automatically. In the example of FIG. 7H, the view includes an application information pane, an application launch pane, an operating system support pane, and a required system components pane.

In the application information pane, general information about a title may be specified. This information may be stored within the record (e.g., a .stw file) and may be used to track processed titles. Some of the information may also be used to generate stream and token files, as described later. The short name is used in naming the token and stream files and the short name determines the title name the end user sees on a software player, as described later. The information may also be used to create an application install file for a server, as described later. Most of this information may come from the publisher of the application, but Program Description (text) field may include comments about the application that may, for example, be entered by a processing organization. This information may or may not be included in the record for informational purposes only (e.g., the information would not be used to generate a stream file). This information may also be pulled into a database to manage the processed applications.

In the application launch pane (FIG. 7H), fields may include a command line that starts the application and a working directory from which the application locates associated files. Typically, the working directory is the same as the directory used in the command line, but this is not always the case.

In the operating system support pane (FIG. 7H), operating systems with which the application is compatible are indicated. This information may be stored in a token file, as described later, so that when a token file is accessed the software player can determine whether the application is compatible with a user's operating system.

In the required system components pane (FIG. 7H), components required for use with the application are indicated. This information may be stored in a token file, as described later, and the software player may provide a warning message when a user attempts to use software without required components. Alternatively, the software player may simply not allow the application to start without required components.

Referring once again to FIG. 6, the flowchart continues at block 224 with creating a streaming application according to the record. The streaming application may include an STC file, a token file, a text file, or some combination of these or other files that facilitate the streaming of an application associated with the application installer.

The flowchart continues at decision point 226 with determining whether an update exists. If an update exists (226-Y), then the flowchart continues at optional block 228 with executing an update installer and continues from block 218 as described previously. Block 228 is optional because updates are not necessary. It should be noted that the system may or may not include an application record (e.g., a .stw file) that includes data from the installation of the application to be updated. In this example, at block 224, creating a streaming application involves merging the stored record with a new record associated with the update installer. Any number of updates, patches, or other applications may be incorporated into the streaming application in this manner.

FIGS. 7I-7K are intended to illustrate use of a GUI to accomplish the creation of a streaming file according to an embodiment. FIG. 7I depicts the GUI of FIG. 7A with the file drop-down menu open and the “Create Token/STC Files” menu option highlighted. In the example of FIG. 7I, when the “Create Token/STC Files” menu option is selected, an Output Files dialogue box, such as the one depicted in FIG. 7J, is displayed. In the Output Files dialogue box of FIG. 7J, an output file name has been provided by, for example, a user. When the OK button is clicked, the SDC files (e.g., Token and STC files) are created. In an embodiment, three files are created and stored in a specified directory. FIG. 7K continues the example and depicts the three files. The three files, in the example of FIG. 7K, are named according to an exemplary naming convention: “app_name”_“uuid”.stc, “app_name”_“uuid”.tok, and “app_name”_“uuid”.txt. The app_name may be the short name described above with reference to FIG. 7H. The uuid value is used to create uniquely identifiable files for each build. In an embodiment, the .stc file is put on a stream server and used to stream the associated application. In an embodiment, the .tok file is similar to the .tok file that is put on a token server. In an embodiment, the .txt file is used to install the application onto a server.

Referring once again to FIG. 6, if there are no additional updates (226-N) the flowchart continues at optional block 230 with copying the streaming application to a testing computer. Block 230 is optional because a testing computer need not be used. For example, the streaming application could be tested on the same computer that executes the installer or performs processing.

The flowchart ends at optional block 232 with testing the streaming application. Block 232 is optional because testing is optional (though recommended). When testing, a user may execute the .tok file to start a software player and the associated application. The application can be tested to verify that it works correctly. The application may then be jumpstarted.

Jumpstarting is a process of specifying which stream blocks of the application need to be in a streaming software player cache before the application starts to run. A variable amount of data may be cached for jumpstarting. In general, if a relatively large amount of data is pre-cached, first-run start times tend to be faster and later delays as blocks are loaded on demand tend to be reduced. Note that the second time the application is run, unless flushed from the cache, application start-up times may be faster given that the application is loaded from the disk cache.

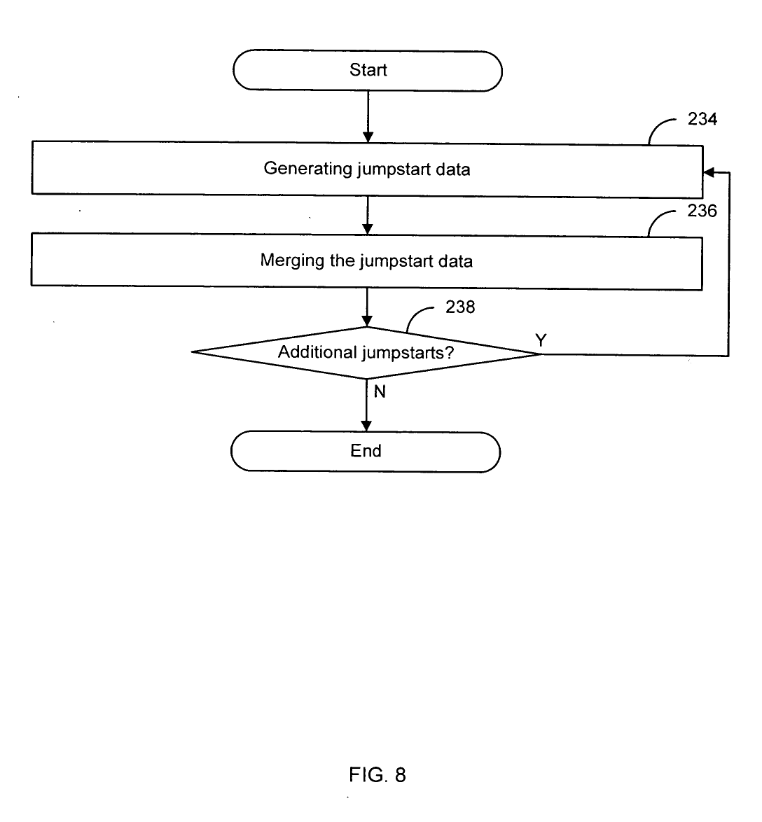

FIG. 8 depicts a flowchart of a method for performing jumpstart. The flowchart starts at block 234 with generating jumpstart data. Jumpstart data may be generated by, for example, executing a streaming application for a period of time. In the context of games, jumpstart data could be generated by completing a level (e.g., “Level One”) of a game. The jumpstart data identifies the blocks that were used when generating the jumpstart data. For example, if when generating the jumpstart data, a computer accesses blocks 1, 2, and 3 of the streaming application (e.g., of a .stc file), then the jumpstart data will include an identifier or pointer to the blocks 1, 2, and 3. Later, when the streaming application is jumpstarted, it is known that blocks 1, 2, and 3 will likely be needed. Accordingly, blocks 1, 2, and 3 are provided prior to running the application. For example, a computer may download blocks 1, 2, and 3 initially. This is useful to prevent “jerky” or slow startup of streaming applications.

The flowchart continues at block 236 with merging the jumpstart data into a record associated with the streaming application. For example, the jumpstart data may be stored in a .stj file. A .stw may include the record of the streaming application that can be used to generate a streaming application. At block 236, the .stj file is merged with the .stw file to create a new record (e.g., a new .stw file). The new .stw file may be used to generate a new streaming application (e.g., a new .tok, .stc, and .txt file). The new streaming application is configured to ensure that a computer to receive the streaming application first downloads the jumpstart, as described previously.

The flowchart continues at decision point 238 with determining whether additional jumpstarts are desired. If so, the flowchart returns to block 234 and continues from there. In an embodiment, one or more additional jumpstarts may be created to improve streaming performance. An additional, or secondary, jumpstart may facilitate improved performance after the streaming has begun. For example, in the context of games the first, or primary, jumpstart may download blocks used in “Level One” of the game. When the streaming of the game begins, the computer can download blocks used in later parts of the game in the background while a player conquers “Level One”. This can improve performance of streaming after the initial jumpstart period.

When all jumpstart data has been generated and merged, the flowchart ends.

While this invention has been described in terms of certain embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention; the invention is limited only by the claims.

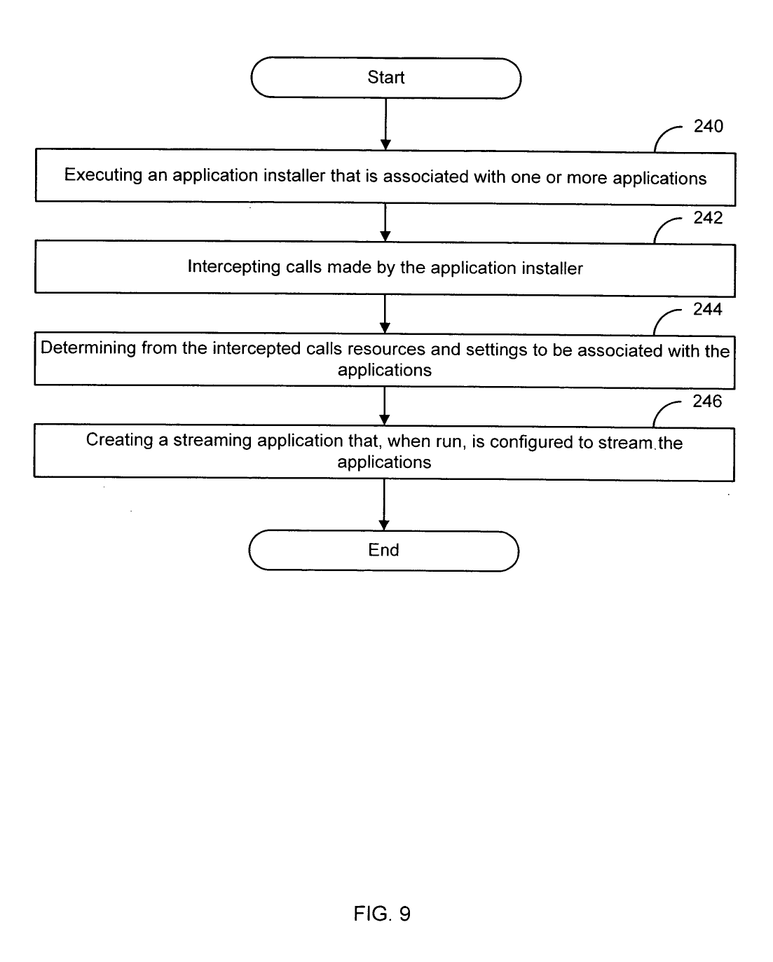

FIG. 9 depicts a flowchart of an exemplary method according to an embodiment. The flowchart begins at block 240 with executing an application installer, wherein the application installer is associated with one or more applications. The flowchart continues at block 242 with intercepting calls made by the application installer. The flowchart continues at block 244 with determining from the intercepted calls resources and settings to be associated with the applications. The flowchart ends at block 246 with creating a streaming application that, when run, is configured to stream the applications.

What is claimed is:

1. A method comprising:
executing an application installer, wherein the application installer is associated with one or more applications;
intercepting calls made by the application installer;
determining from the intercepted calls settings to be associated with the applications; and
creating a streaming application that, when run, is configured to stream the applications.

2. The method of claim 1, further comprising:
associating an update with the applications;
executing an update installer associated with the update;
intercepting calls made by the update installer;
determining from the intercepted calls resources and settings to be associated with the update; and
updating the streaming application according to settings and resource requirements of the update.

3. The method of claim 1, further comprising:
creating an initial streaming application;
capturing jumpstart data; and
merging the jumpstart data into the initial streaming application.

4. The method of claim 1, further comprising:
capturing jumpstart data for logical subdivisions of the applications;
merging the jumpstart data for each of the logical subdivisions; and
rebuilding the streaming application using the merged jumpstart data.

5. The method of claim 1, further comprising determining from the intercepted calls resources to be associated with the applications.

6. A system comprising:
a means for executing an application installer, wherein the application installer is associated with one or more applications;
a means for intercepting calls made by the application installer;
a means for determining from the intercepted calls resources and settings to be associated with the applications; and
a means for creating a streaming application that, when run, is configured to stream the applications.

7. The system of claim 6, further comprising:
a means for associating an update with the applications;
a means for executing an update installer associated with the update;
a means for intercepting calls made by the update installer;
a means for determining from the intercepted calls resources and settings to be associated with the update; and
a means for updating the streaming application according to settings and resource requirements of the update.

8. The system of claim 6, further comprising:
a means for creating an initial streaming application;
a means for capturing jumpstart data; and
a means for merging the jumpstart data into the initial streaming application.

9. The system of claim 6, further comprising:
a means for capturing jumpstart data for logical subdivisions of the applications;
a means for merging the jumpstart data for each of the logical subdivisions; and
a means for rebuilding the streaming application using the merged jumpstart data.

10. The system of claim 6, wherein the calls made by the application installer are associated with modification of a registry value.

11. The system of claim 6, wherein the calls made by the application installer are associated with modification of a file.

12. The system of claim 6, further comprising a means for determining from the intercepted calls resources to be associated with the applications.

13. A system comprising:
an application installer execution module configured to at least partially provide an environment in which an application installer is executed, wherein the application installer is associated with one or more applications;
an interception module configured to intercept calls made by the application installer while executed in the environment;
a recording module configured to record installation-related data and infer settings to be associated with the applications from the intercepted calls; and
a streaming application creation module configured to create a streaming application that, when run, is configured to stream the applications.

14. The system of claim 13, further comprising:
an update installer for executing an update installer associated with an update to an application;
wherein the interception module intercepts calls made by the update installer;
wherein the recording module records settings to be associated with the update; and
wherein the streaming application creation module updates the streaming application according to recorded settings.

15. The system of claim 13, wherein the streaming application creation module creates an initial streaming application, further comprising a testing computer that is used to capture jumpstart data, wherein the streaming application creation module merges the jumpstart data into the initial streaming application.

16. The system of claim 13, wherein when jumpstart data for logical subdivisions of a streaming application has been captured, the streaming application creation module facilitates merging the jumpstart data for each of the logical subdivisions and rebuilding the streaming application using the merged jumpstart data.

17. The system of claim 13, wherein the calls made by the application installer are associated with modification of a registry.

18. The system of claim 13, wherein the calls made by the application installer are associated with modification of a file.

19. The system of claim 13, further comprising a streaming application creation module that determines from the intercepted calls resources to be associated with the applications.

20. The system of claim 13, wherein the streaming application includes a token file and a stream file.
